(19) United States
(12) Patent Application Publication
(10) Pub. No.: US 2005/0099817 A1
(43) Pub. Date: May 12, 2005

(54) Ceiling fixture

(76) Inventor: Kuo Kuang Lin, Taipei (TW)

Correspondence Address: DAVID AND RAYMOND PATENT GROUP, 1050 OAKDALE LANE, ARCADIA, CA, 91006, US

(21) Appl. No.: 10/705,352

(22) Filed: Nov. 10, 2003

(51) Int. Cl. F21S 8/06

(52) U.S. Cl. 362/404

(57) ABSTRACT

A ceiling fixture includes a ceiling supporting frame adapted for mounting on a ceiling, a light source supported by the ceiling supporting frame, and a light casing, which is mounted underneath the ceiling supporting frame, having a main light chamber and a light enhancing chamber which is formed between the light casing and the ceiling supporting frame and is communicating with the main light chamber, wherein the light source is disposed within the main light chamber in such a manner that when the light source produces light, the light is directed within the main light chamber to outside through the light casing while the light is guided to radially dispense from the main light chamber to outside through the light enhancing chamber for providing an added light effect of the ceiling fixture.

### BACKGROUND OF THE PRESENT INVENTION

1. Field of Invention

The present invention relates to a ceiling lighting apparatus, and more particularly to a ceiling fixture, which has a main light chamber for a light source disposed therewithin for illumination and a light enhancing chamber communicating with the main light chamber for radially projecting the light from the light source so as to enhance the aesthetic light effect of the ceiling fixture.

2. Description of Related Arts

Ceiling lights are commonly used to mount on a ceiling for illumination. A convention ceiling light comprises a mounting frame adapted for mounting on the ceiling and a light casing mounted underneath the mounting frame wherein a light source is supported by the mounting frame within the light casing in such a manner that when the light source is electrically connected with a power source, the light source produces light to outside through the light casing for illumination. Since the light source, such as a light bulb, produces not only lights but also heat, the conventional ceiling light generally comprises a heat insulating layer mounted between the ceiling and the mounting frame for blocking the heat from the light source towards the ceiling.

It is no doubt that such ceiling light can achieve the illumination purpose. However, the ceiling light is considered as one of the decorative element for home decoration because a light effect can be enhanced the aesthetic appearance of the room. Therefore, a ceiling light having an additional light effect is a needed.

Accordingly, in order to provide an added light effect, the ceiling light must incorporate with more than one light source such that one of the light sources is mainly arranged for illumination while another light source provides a soft light intensity for enhancing the aesthetic light appearance. However, such dual light source arrangement has several drawbacks.

As it is mentioned each of the light sources produces not only lights but also heat, the dual light source arrangement will substantially produces a large amount of heat which may damage the ceiling. In other words, the heat insulating layer must be thickened to block the heat from the dual light source arrangement. In addition, the space of the light housing must be large enough to dispose the dual light source arrangement therein so as to substantially increase the overall size of the ceiling light. Thus, the dual light source arrangement not only increases the manufacturing cost of the ceiling light but also complicates the electrical configuration of the ceiling light. If one of the light sources is short circuit, another light source will not functioning properly.

Alternatively, the light housing has a plurality of enhancing grooves formed thereon for softening the light from the light source so as to provide an added light effect of the ceiling light. However, once the light is softened by the light housing, the light intensity of the ceiling light may not be strong enough for illumination. Therefore, it is always a conflict of the ceiling light between illumination and decoration.

### SUMMARY OF THE PRESENT INVENTION

A main object of the present invention is to provide a ceiling fixture, which has a main light chamber for a light source disposed therewithin for illumination and a light enhancing chamber communicating with the main light chamber for radially projecting the light from the light source so as to enhance the aesthetic light effect of the ceiling fixture.

Another object of the present invention is to provide a ceiling fixture, which requires one single light source to provide both illumination and decoration purposes so as to substantially minimize the heat generated by the light source and simplify the electrical configuration of the ceiling fixture.

Another object of the present invention is to provide a ceiling fixture, wherein the light enhancing frame is supported between the ceiling mounting frame and the light casing to form the light enhancing chamber radially projecting from the main light chamber, such that the light enhancing frame not only provides an added light effect for decoration but also enhances the heat dispersing from the light source.

Another object of the present invention is to provide a ceiling fixture, wherein no expensive or complicated structure is required in order to achieve the above objects. Therefore, the present invention successfully provides an economic and efficient solution for providing not only a sufficient light intensity for illumination but also an added light effect by one single light source.

Accordingly, in order to accomplish the above objects, the present invention provides a ceiling fixture for mounting on a ceiling, comprising:
a ceiling supporting frame adapted for securely mounting on the ceiling;
a light source, which is arranged for electrically connecting to a power supply, supported by the ceiling supporting frame; and
a light casing, which is mounted underneath the ceiling supporting frame, having a main light chamber and a light enhancing chamber which is formed between the light casing and the ceiling supporting frame and is communicating with the main light chamber, wherein the light source is disposed within the main light chamber in such a manner that when the light source produces light, the light is directed within the main light chamber to outside through the light casing while the light is guided to radially dispense from the main light chamber to outside through the light enhancing chamber for providing an added light effect of the ceiling fixture.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a ceiling fixture according to a preferred embodiment of the present invention.

FIG. 2 is an exploded perspective view of the ceiling fixture according to the above preferred embodiment of the present invention.

FIG. 3 is a sectional view of the ceiling fixture according to the above preferred embodiment of the present invention.

FIG. 4 illustrates an alternative mode of the ceiling fixture according to the above preferred embodiment of the present invention.

### DETAILED DESCRIPTION OF THE PREFERRED EMBODIMENT

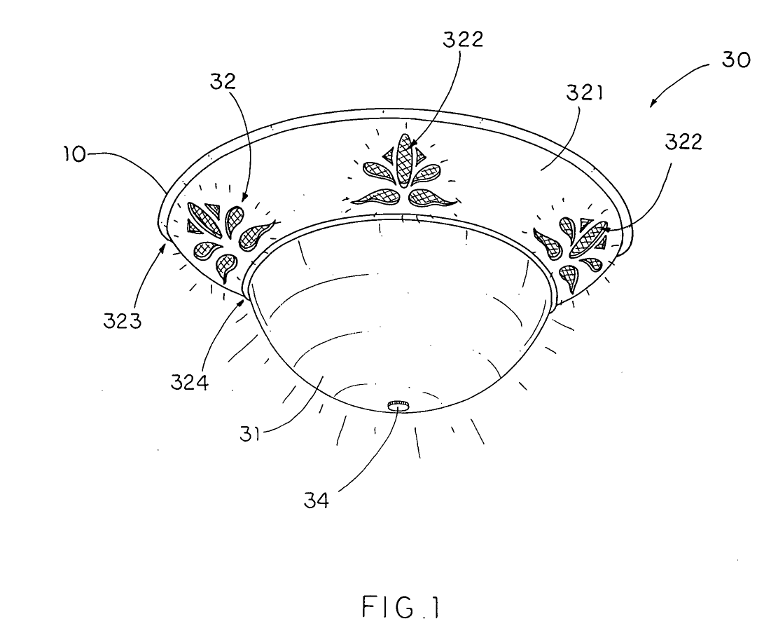

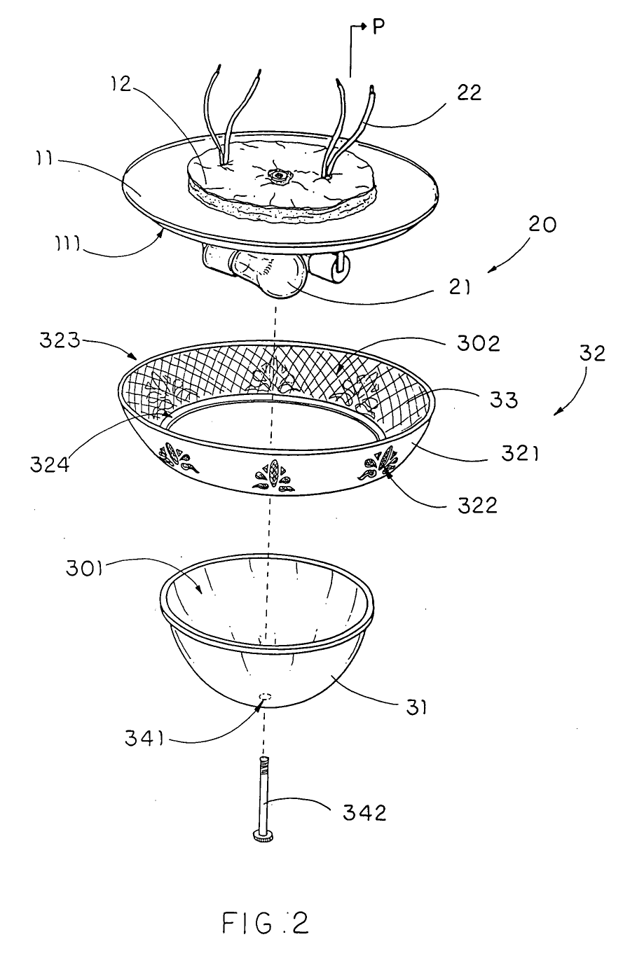

Referring to FIGS. 1 and 2 of the drawings, a ceiling fixture for mounting on a ceiling according to a preferred embodiment of the present invention is illustrated, wherein the ceiling fixture comprises a ceiling supporting frame 10 adapted for securely mounting on the ceiling, and a light source 20, which is arranged for electrically connecting to a power supply P, supported by the ceiling supporting frame 10.

The ceiling fixture further comprises a light casing 30, which is mounted underneath the ceiling supporting frame 10, having a main light chamber 301 and a light enhancing chamber 302 which is formed between the light casing 30 and the ceiling supporting frame 10 and is communicating with the main light chamber 301, wherein the light source 20 is disposed within the main light chamber 301 in such a manner that when the light source 20 produces light, the light is directed within the main light chamber 301 to outside through the light casing 30 while the light is guided to radially dispense from the main light chamber 301 to outside through the light enhancing chamber 302 for providing an added light effect of the ceiling fixture.

According to the preferred embodiment, the ceiling supporting frame 10 comprises a ceiling panel 11 for securely mounting on the ceiling and a heat insulating layer 12 provided on the ceiling panel 11 for blocking the heat from the light source 20 towards the ceiling.

The light source 20 comprises an illuminator 21 supported underneath the ceiling panel 11 of the ceiling supporting frame 10 and an electric cable 22 electrically extended from the illuminator 21 through the ceiling panel 11 for electrically connecting the illuminator 21 to the power supply P. According to the preferred embodiment, the illuminator 21 is a light bulb supported underneath the ceiling panel 11 wherein the illuminator 21 is adapted for producing light having a predetermined light intensity for illumination. Accordingly, the ceiling panel 11 has a bottom light reflective surface 111 for substantially reflecting the light from the light source 20 towards the main light chamber 301 and the light enhancing chamber 302.

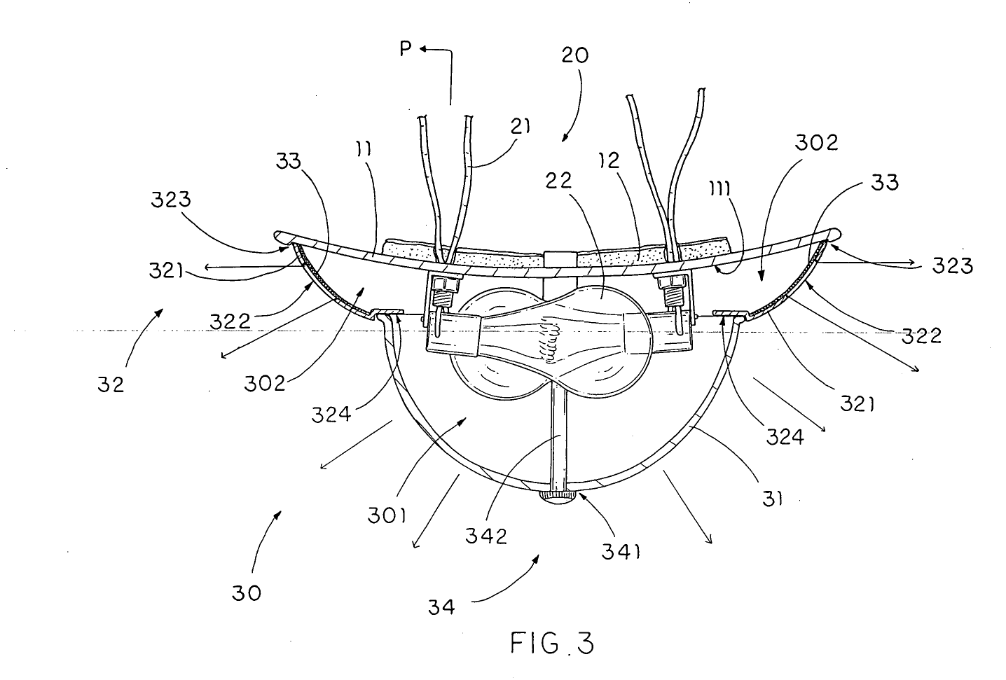

As shown in FIGS. 2 and 3, the light casing 30 comprises a light dispersing housing 31 defining the main light chamber 301 therewithin and a light enhancing frame 32 having a surrounding wall 321 coaxially extended from the ceiling supporting frame 10 to the light dispersing housing 31 wherein the light enhancing chamber 301 is defined within the surrounding wall 321 of the light enhancing frame 32 to communicate with the main light chamber 301.

The light casing 30 further comprises means 34 for detachably locking the light dispersing housing 31 to the ceiling supporting frame 10. The locking means 34 has a center hole 341 formed on the light dispensing housing 31 and a locking shaft 342 having an enlarged head and a locking tail slidably extended through center hole 341 to detachably lock at the ceiling panel 11 of the ceiling supporting frame 10 so as to retain the light dispersing housing 31 via the enlarged head of the locking shaft 342. It is worth to mention that when the light dispensing housing 31 is locked with the ceiling supporting frame 10 via the locking shaft 342, the light enhancing frame 32 is securely supported between the light dispensing housing 31 and the ceiling supporting frame 10 so as to prevent an unwanted lateral movement of the light enhancing frame 32.

The light dispersing housing 31, having a semi-spherical shaped, is supported underneath the ceiling panel 11 of the ceiling supporting frame 10 wherein the light source 20 is disposed within the main light chamber 301 of the light dispersing housing 31 such that when the light source 20 generates the light within the main light chamber 301, the light is capable of passing through the light dispersing housing 31 to outside for illumination.

As shown in FIG. 3, the light enhancing frame 32, having a ring shaped, further has a plurality of light enhancing windows 322 spacedly formed on the surrounding wall 321 to communicate the light enhancing chamber 302 with outside in such a manner that when the light from the light source 20 is projected from the main light chamber 301 to the light enhancing chamber 302, the light is capable of radially dispersing to outside through the light enhancing windows 322 for providing an added light effect of the ceiling fixture of the present invention.

According to the preferred embodiment, the light enhancing windows 322 are respectively embodied as through grooves which are spacedly formed on the surrounding wall 321 of the light enhancing frame 32 and are radially projected from the light enhancing chamber 302 so as to guide the light radially dispensing from the light enhancing chamber 302 to outside. It is worth to mention each of the light enhancing windows 322 can be shaped in an artistically aesthetic manner for further enhancing the added light effect of the ceiling fixture.

Accordingly, an upper surrounding edge 323 of the light enhancing frame 32 is coaxially extended from the ceiling supporting frame and a lower surrounding edge 324 of the light enhancing frame 32 is coaxially extended to couple with the light dispersing housing 31, wherein the light enhancing frame 32 has a diameter gradually reducing from the upper surrounding edge 323 to the lower surrounding edge 324 such that the surrounding wall 321 of the light enhancing frame 32 is inclinedly extended from the ceiling supporting frame 10 to the light dispersing housing 31. Therefore, the shape of the light enhancing frame 32 controls the amount of light from the light source 20 to disperse towards the light enhancing chamber 302 so as to diminish the light intensity within the light enhancing chamber 302.

As shown in FIG. 2, the lower surrounding edge 324 of the light enhancing frame 32 is shaped as a retaining rim substantially biasing against a circumferential edge of the light dispensing housing 31 wherein the retaining rim of the light enhancing fame 32 is coaxially and inwardly extended between the main light chamber 301 and the light enhancing chamber 302 for controlling the light passing from the main light chamber 301 towards the light enhancing chamber 302. In other words, a small amount of light is needed from the light source 20 passing towards the light enhancing chamber 302 to provide the added light effect while most of the light from the light source 20 should project towards the mina light chamber 301 for illumination.

It is worth to mention that since the light source 20 is disposed within the main light chamber 301, the light intensity within the main light chamber 301 is higher than the light intensity within the light enhancing chamber 302. Therefore, the light is brighter at the light dispersing housing 31 for mainly illumination than within the light enhancing chamber 302 for providing an added light effect through the light enhancing windows 322.

As shown in FIGS. 2 and 3, the light casing 30 further comprises a light softening layer 33 provided on an inner side of the surrounding wall 321 of the light enhancing frame 32 to cover on the light enhancing windows 322 for softening the light dispersing from the light enhancing chamber 302 to outside through the light enhancing windows 322. Accordingly, the light softening layer 33 is a fabric affixed to the inner side of the surrounding wall 321 to cover the light enhancing windows 322.

It is mentioned that the light source 20 produces not only lights but also heat. Since the light enhancing chamber 302 is positioned above the main light chamber 301, the heat from the light source 20 is adapted to be effectively dispersed from the light enhancing chamber 302 to outside through the light enhancing windows 322. Therefore, the structural configuration of the ceiling fixture not only provides an added light effect for decoration but also enhances the heat dispersing from the light source 20. It is worth to mention that only one light source 20 is required to provide both illumination purpose and decoration purpose so as to simplify the electrical configuration of the light source 20 to electrically connect with the power supply P.

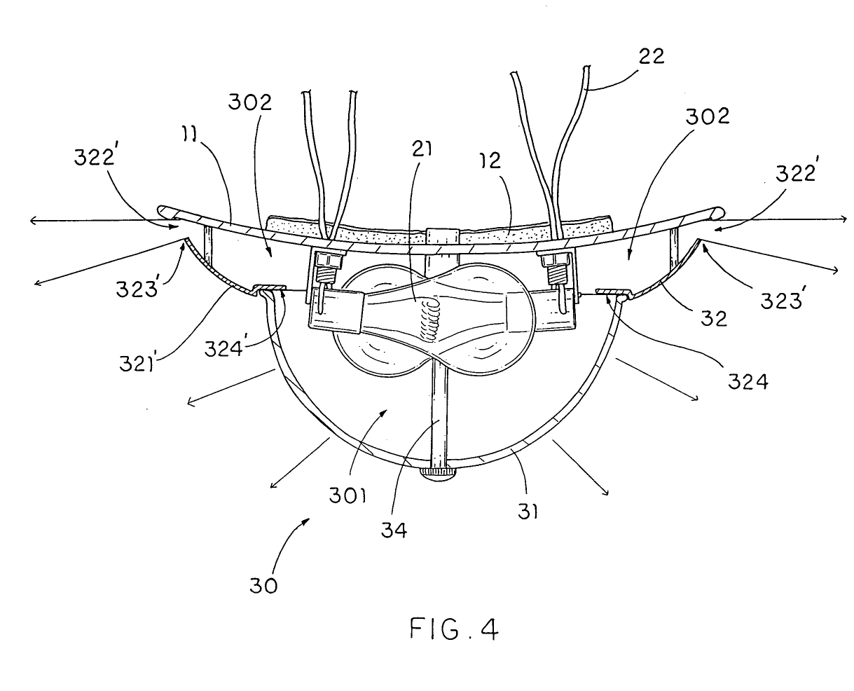

FIG. 4 illustrates an alternative mode of the light enhancing frame 32′ which has a surrounding wall 321′ coaxially extended from the ceiling supporting frame 10 to the light dispersing housing 31 wherein the light enhancing chamber 301 is defined within the surrounding wall 321′ of the light enhancing frame 32′ to communicate with the main light chamber 301.

The light enhancing frame 32′ further has a light dispensing groove 322′ formed between an upper surrounding edge 323′ of the surrounding wall 321′ and the ceiling supporting frame 10 to communicate the light enhancing chamber 302 with outside in such a manner that when the light from the light source 20 is projected from the main light chamber 301 to the light enhancing chamber 302, the light is capable of radially dispersing to outside through the light enhancing groove 322′ for providing an added light effect of the ceiling fixture.

Accordingly, the light enhancing frame 32′ has a diameter gradually reducing from the upper surrounding edge 323′ to a lower surrounding edge 324′ such that the surrounding wall 321′ of the light enhancing frame 32′ is inclinedly extended from the ceiling supporting frame 10 to the light dispersing housing 31 to form the light enhancing chamber 302 having a light intensity lower than a light intensity within the main light chamber 301.

The lower surrounding edge 324′ of the light enhancing frame 32′ is shaped as a retaining rim substantially biasing against a circumferential edge of the light dispensing housing 31 wherein the retaining rim of the light enhancing fame 32′ is coaxially and inwardly extended between the main light chamber 301 and the light enhancing chamber 302 for controlling the light passing from the main light chamber 301 towards the light enhancing chamber 302.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

1. A ceiling fixture for mounting on a ceiling, comprising:
a ceiling supporting frame adapted for securely mounting on said ceiling;
a light source, which is arranged for electrically connecting to a power supply, supported by said ceiling supporting frame; and
a light casing, which is mounted underneath said ceiling supporting frame, having a main light chamber and a light enhancing chamber which is formed between said light casing and said ceiling supporting frame and is communicating with said main light chamber, wherein said light source is disposed within said main light chamber in such a manner that when said light source produces light, said light is directed within said main light chamber to outside through said light casing while said light is guided to radially dispense from said main light chamber to outside through said light enhancing chamber for providing an added light effect of said ceiling fixture.

2. The ceiling fixture, as recited in claim 1, wherein said light casing comprises a light dispersing housing defining said main light chamber therewithin and a light enhancing frame having a surrounding wall coaxially extended from said ceiling supporting frame to said light dispersing housing, wherein said light enhancing chamber is defined within said surrounding wall of said light enhancing frame to communicate with said main light chamber.

3. The ceiling fixture, as recited in claim 2, wherein said light enhancing frame further has a plurality of light enhancing windows spacedly formed on said surrounding wall to communicate said light enhancing chamber with outside in such a manner that when said light from light source is projected from said main light chamber to said light enhancing chamber, said light is radially dispersing to outside through said light enhancing windows.

4. The ceiling fixture, as recited in claim 3, wherein said light enhancing windows are respectively through grooves which are spacedly formed on said surrounding wall of said light enhancing frame and are radially projected from said light enhancing chamber so as to guide the light radially dispensing from said light enhancing chamber to outside.

5. The ceiling fixture, as recited in claim 2, wherein an upper surrounding edge of said light enhancing frame is coaxially extended from said ceiling supporting frame and a lower surrounding edge of said light enhancing frame is coaxially extended to couple with said light dispersing housing, wherein said light enhancing frame has a diameter gradually reducing from said upper surrounding edge to said lower surrounding edge such that said surrounding wall of said light enhancing frame is inclinedly extended from said ceiling supporting frame to said light dispersing housing to form said light enhancing chamber having a light intensity lower than a light intensity within said main light chamber.

6. The ceiling fixture, as recited in claim 3, wherein an upper surrounding edge of said light enhancing frame is coaxially extended from said ceiling supporting frame and a lower surrounding edge of said light enhancing frame is coaxially extended to couple with said light dispersing housing, wherein said light enhancing frame has a diameter gradually reducing from said upper surrounding edge to said lower surrounding edge such that said surrounding wall of said light enhancing frame is inclinedly extended from said ceiling supporting frame to said light dispersing housing to form said light enhancing chamber having a light intensity lower than a light intensity within said main light chamber.

7. The ceiling fixture, as recited in claim 4, wherein an upper surrounding edge of said light enhancing frame is coaxially extended from said ceiling supporting frame and a lower surrounding edge of said light enhancing frame is coaxially extended to couple with said light dispersing housing, wherein said light enhancing frame has a diameter gradually reducing from said upper surrounding edge to said lower surrounding edge such that said surrounding wall of said light enhancing frame is inclinedly extended from said ceiling supporting frame to said light dispersing housing to form said light enhancing chamber having a light intensity lower than a light intensity within said main light chamber.

8. The ceiling fixture, as recited in claim 5, wherein said lower surrounding edge of said light enhancing frame is shaped as a retaining rim substantially biasing against a circumferential edge of said light dispensing housing, wherein said retaining rim of said light enhancing fame is coaxially and inwardly extended between said main light chamber and said light enhancing chamber for controlling said light passing from said main light chamber towards said light enhancing chamber.

9. The ceiling fixture, as recited in claim 6, wherein said lower surrounding edge of said light enhancing frame is shaped as a retaining rim substantially biasing against a circumferential edge of said light dispensing housing, wherein said retaining rim of said light enhancing fame is coaxially and inwardly extended between said main light chamber and said light enhancing chamber for controlling said light passing from said main light chamber towards said light enhancing chamber.

10. The ceiling fixture, as recited in claim 7, wherein said lower surrounding edge of said light enhancing frame is shaped as a retaining rim substantially biasing against a circumferential edge of said light dispensing housing, wherein said retaining rim of said light enhancing fame is coaxially and inwardly extended between said main light chamber and said light enhancing chamber for controlling said light passing from said main light chamber towards said light enhancing chamber.

11. The ceiling fixture, as recited in claim 3, wherein said light casing further comprises a light softening layer provided on an inner side of said surrounding wall of said light enhancing frame to cover on said light enhancing windows for softening said light dispersing from said light enhancing chamber to outside through said light enhancing windows.

12. The ceiling fixture, as recited in claim 7, wherein said light casing further comprises a light softening layer provided on an inner side of said surrounding wall of said light enhancing frame to cover on said light enhancing windows for softening said light dispersing from said light enhancing chamber to outside through said light enhancing windows.

13. The ceiling fixture, as recited in claim 10, wherein said light casing further comprises a light softening layer provided on an inner side of said surrounding wall of said light enhancing frame to cover on said light enhancing windows for softening said light dispersing from said light enhancing chamber to outside through said light enhancing windows.

14. The ceiling fixture, as recited in claim 4, wherein said ceiling supporting frame comprises a ceiling panel supporting said light source thereunder for securely mounting on said ceiling, and a heat insulating layer provided on said ceiling panel for blocking heat from said light source towards said ceiling, wherein said ceiling panel has a bottom light reflective surface for substantially reflecting said light from said light source towards said light enhancing chamber.

15. The ceiling fixture, as recited in claim 10, wherein said ceiling supporting frame comprises a ceiling panel supporting said light source thereunder for securely mounting on said ceiling, and a heat insulating layer provided on said ceiling panel for blocking heat from said light source towards said ceiling, wherein said ceiling panel has a bottom light reflective surface for substantially reflecting said light from said light source towards said light enhancing chamber.

16. The ceiling fixture, as recited in claim 13, wherein said ceiling supporting frame comprises a ceiling panel supporting said light source thereunder for securely mounting on said ceiling, and a heat insulating layer provided on said ceiling panel for blocking heat from said light source towards said ceiling, wherein said ceiling panel has a bottom light reflective surface for substantially reflecting said light from said light source towards said light enhancing chamber.

17. The ceiling fixture, as recited in claim 2, wherein said light enhancing frame further has a light dispensing groove formed between an upper surrounding edge of said surrounding wall and said ceiling supporting frame to communicate said light enhancing chamber with outside in such a manner that when said light from said light source is projected from said main light chamber to said light enhancing chamber, said light is radially dispersing to outside through said light enhancing groove.

18. The ceiling fixture, as recited in claim 17, wherein said light enhancing frame has a diameter gradually reducing from said upper surrounding edge to a lower surrounding edge such that said surrounding wall of said light enhancing frame is inclinedly extended from said ceiling supporting frame to said light dispersing housing to form said light enhancing chamber having a light intensity lower than a light intensity within said main light chamber.

19. The ceiling fixture, as recited in claim 18, wherein said lower surrounding edge of said light enhancing frame is shaped as a retaining rim substantially biasing against a circumferential edge of said light dispensing housing, wherein said retaining rim of said light enhancing fame is coaxially and inwardly extended between said main light chamber and said light enhancing chamber for controlling said light passing from said main light chamber towards said light enhancing chamber.

20. The ceiling fixture, as recited in claim 19, wherein said ceiling supporting frame comprises a ceiling panel supporting said light source thereunder for securely mounting on said ceiling, and a heat insulating layer provided on said ceiling panel for blocking heat from said light source towards said ceiling, wherein said ceiling panel has a bottom light reflective surface for substantially reflecting said light from said light source towards said light enhancing chamber.
